(19) United States
(12) Patent Application Publication
(10) Pub. No.: US 2025/0035657 A1
(43) Pub. Date: Jan. 30, 2025

(54) WINDOW DEFOGGER FOR SAMPLE PREPARATION SYSTEM

(71) Applicant: Beckman Coulter, Inc., Brea, CA (US)

(72) Inventor: Simon A. NAVA, Miami, FL (US)

(73) Assignee: Beckman Coulter, Inc., Brea, CA (US)

(21) Appl. No.: 18/716,069

(22) PCT Filed: Dec. 2, 2022
(86) PCT No.: PCT/US2022/080851

§ 371 Date: Jun. 3, 2024

Related U.S. Application Data
(60) Provisional application No. 63/294,736, filed on Dec. 29, 2021.
(60) Provisional application No. 63/285,737, filed on Dec. 3, 2021.

(51) Int. Cl. G01N 35/02; G01N 35/00

(52) U.S. Cl. CPC G01N 35/025; G01N 35/00732; G01N 2035/00306; G01N 2035/00346; G01N 2035/00752

(57) ABSTRACT

A system for acquiring the image data of refrigerated materials is disclosed. The system includes a material management unit with an imaging system. The material management unit further includes a refrigerated chamber in which material vials are stored. The imaging system includes a window positioned on the side of the material management unit that separates an interior space of the refrigerated chamber from an exterior space of the material management unit. The imaging system further includes a camera positioned in the exterior space that captures image data through the window. The window is heated along its sides by a heating element, which functions to prevent condensation from forming on the surface of the window.

This application is being filed on Dec. 2, 2022, as a PCT International Patent application and claims the benefit of and priority to U.S. Provisional patent application Ser. No. 63/285,737, filed Dec. 3, 2021, and U.S. Provisional patent application Ser. No. 63/294,736, filed Dec. 29, 2021, the entire disclosures of which are incorporated by reference herein in their entirety.

### BACKGROUND

In some situations, when storing or preparing certain chemicals or biological materials, the materials must be kept at a specific temperature. Depending on the material, these temperatures may be significantly colder than room temperature, in which case, the materials must be kept refrigerated. Likewise, the materials may be light sensitive, in which case, the materials must be shielded from damaging light sources. Refrigerated chambers are used to store these materials and shield them from external light sources. When placing materials in a refrigerated chamber, it may be necessary to keep an accurate catalogue or inventory of what materials are stored therein. Therefore, it is desirable to have some method of quickly ascertaining the identity of the materials housed within the refrigerated chamber.

### SUMMARY

In general terms, this disclosure is directed to a material management unit and a method performed by the material management unit for obtaining image data of materials stored therein. In one possible configuration and by non-limiting example, the material management unit houses a plurality of material storage vials at a refrigerated temperature. The material management unit includes a window through which a camera can capture image data of an interior space of the material management unit. A heating element is positioned along the edges of the window to heat the window and prevent condensation from forming on its exterior surface. Various aspects are described in this disclosure, which include, but are not limited to, the following aspects.

One aspect of the present disclosure is a material management unit. The material management unit comprises a refrigerated chamber with an interior refrigerated space. The refrigerated space is held at a lower temperature than an exterior space outside of the refrigerated chamber. The material management unit further comprises a window positioned on the material management unit separating the exterior space from the refrigerated space. The window comprises a first surface that is exposed to the exterior space, a second surface that is exposed to the refrigerated space, and a third surface that spans between the first surface and the second surface. The material management unit also includes a heating element configured to apply heat to the third surface of the window. The material management unit further includes a camera positioned in the exterior space and oriented to capture image data of the refrigerated space through the window.

Another aspect of the present disclosure is a thermal window unit. The thermal window unit comprises a window with a first surface, a second surface, and an edge. The thermal window unit further comprises a heating element configured to apply heat to the edge of the window. The heating element is configured to heat at least one of the first surface and the second surface to at least 35 degrees Celsius.

A further of the present disclosure is an imaging system comprising a window with a first surface, a second surface, and an edge spanning between the first surface and the second surface. The imaging system further comprises a camera with an imaging face oriented to capture image data through the first surface and second surface of the window. The imaging system also comprises a heating element configured to apply heat to the edge of the window.

Another aspect of the present disclosure is a sample preparation unit comprising a material management unit configured to store a plurality of material vials within a refrigerated interior space. The material management unit further comprises a material storage carousel configured to hold the plurality of material vials within the refrigerated interior space. The material management unit also comprises an imaging system. The imaging system comprises a window separating the refrigerated interior space from an exterior space of the material management unit and a camera positioned in the exterior space of the material management unit and configured to capture image data of the interior space through the window. The imaging system further comprises a heating element configured to apply heat to an edge of the window and a transfer station configured to access the material stored within the plurality of the material vials.

A further aspect of the present disclosure is a sample preparation unit comprising a refrigerated chamber having a window and a heating element coupled to the window.

Another aspect of the present disclosure is a method of capturing an image comprising positioning a camera outside of a refrigerated chamber to capture an image of an interior space of the refrigerated chamber though a window. The refrigerated chamber includes the window. The window further comprises a window first surface facing external to the refrigerated chamber, a window second surface facing internal to the refrigerated chamber, and a window side surface extending between the window first surface and the window second surface. The refrigerated chamber further comprises a heating element configured to apply heat to the window side surface. The method also includes operating the camera to capture the image.

A further aspect of the present disclosure is a method of reducing condensation buildup on a window of a refrigerated chamber of a sample preparation unit. The window is positioned between an interior region and an exterior region of the refrigerated chamber and the method comprising applying heat to the window to reduce condensation buildup on an exterior surface of the window.

Another aspect of the present disclosure is a method of identifying a vial within a refrigerated chamber. The method comprises applying heat to a window of the refrigerated chamber and capturing an image of at least a portion of the vial. The vial includes an identifier arranged on the vial, and the image is captured through the heated window. The method also includes identifying the vial using the identifier.

### BRIEF DESCRIPTION OF THE DRAWINGS

FIG. 1 is a front perspective view of an example sample preparation instrument.

FIG. 2 is a top view of the example sample preparation instrument of FIG. 1, depicting the hardware components of the sample preparation instrument.

FIG. 3 is a front perspective view of an example temperature-controlled material management unit in a closed configuration.

FIG. 4 is a cross sectional view of the example temperature-controlled material management unit of FIG. 3

FIG. 5 is another front perspective view of the example temperature-controlled material management unit of FIG. 3 in an open configuration.

FIG. 6 is a perspective view of an example material storage carousel.

FIG. 7 is a perspective view of another example material storage carousel.

FIG. 8 is a perspective view of another example temperature-controlled material management unit.

FIG. 9 is a cross sectional view of the example temperature-controlled material management unit of FIG. 8.

FIG. 10 is a perspective view of an example carousel motor.

FIG. 11 is a rear perspective view of an example temperature-controlled carousel housing module.

FIG. 12 is a cross sectional view of the example temperature-controlled carousel housing module of FIG. 11.

FIG. 13 is an example block diagram depicting the connection between the controller, the camera, light assembly, and heating element.

FIG. 14 is a perspective view of the example window assembly.

FIG. 15 is a perspective view of an example thermal window.

FIG. 16 is a thermal model of the example thermal window of FIG. 15.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

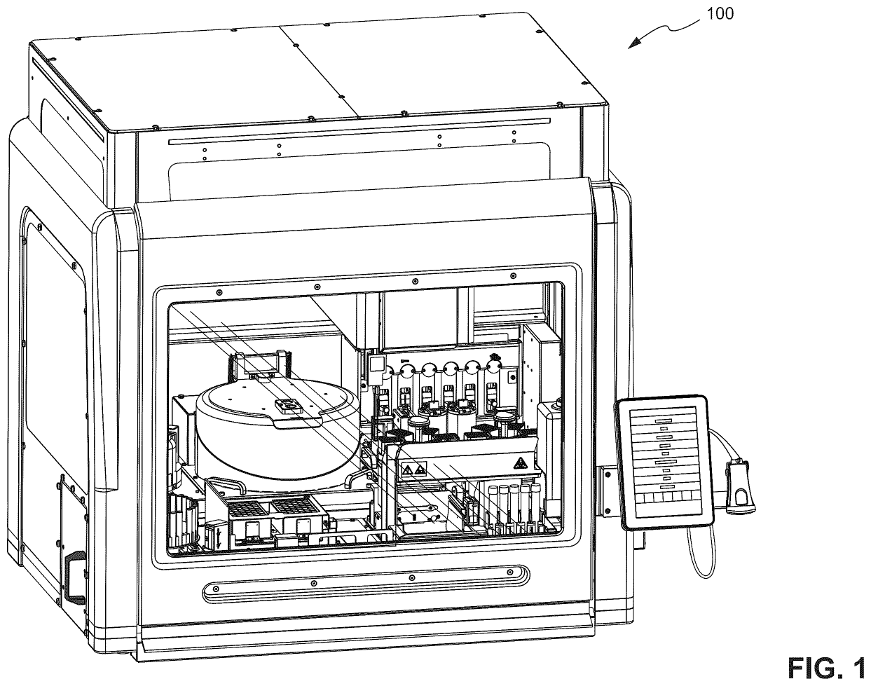

FIG. 1 is an example sample preparation instrument. FIG. 1 depicts an example sample preparation instrument 100. The sample preparation instrument 100 can be used to prepare a sample of a specimen for subsequent analysis, such as for a flow cytometry panel. Example specimens can include whole blood, bone marrow, dissociated tissues, peripheral mononuclear cells, fine needle aspirates, cerebrospinal fluid, and other single cell-suspensions. As one example, a laboratory providing flow cytometry services receives a whole blood specimen to be prepared for a leukemia or lymphoma panel. Constituents of blood include plasma, red blood cells, white blood cells, and platelets. Leukemia or lymphoma affect white blood cells (e.g., cause abnormally high white blood cell counts), and therefore subsets of the white blood cells are the constituent of the blood that is targeted for analysis in the leukemia or lymphoma panel. To prepare a sample of the blood for the panel, a labeling reagent, such as an antibody reagent that attaches to white blood cells, is used to stain the blood. For example, about 100 μL of blood is stained with about 20 μL of the antibody reagent and incubated for about 10 to 20 minutes. The antibody reagent can include a fluorescent dye, for example, that allows for analysis of the white blood cells by flow cytometry. In some examples, cell washing is performed on the blood prior to adding the antibody reagent in order to remove the plasma and associated proteins that interfere with staining (e.g., such that primarily red blood cells and white blood cells remain). A lytic reagent is then added to the sample and incubated to destroy the red blood cells. In some examples, another wash can be performed to slow the lytic activity to avoid destruction of the white blood cells and/or to remove red blood cell debris. The sample can then be analyzed. For example, the leukemia or lymphoma panel can be performed by a flow cytometer.

Currently, to obtain the white blood cell concentration, the specimen is first sent to another laboratory, such as a hematology laboratory, prior to preparing the sample for the flow cytometry panel. Depending on how busy the hematology laboratory is and/or the method by which the hematology laboratory provides results, it can take hours to receive the concentration value. Alternatively, the concentration determination can be kept in-house if the laboratory has a separate hematology analyzer, or uses microscopy techniques to determine the concentration. However, having a separate hematology analyzer can be costly as it is one more instrument to be maintained that takes up valuable bench space, and using microscopy is time consuming and labor-intensive. Additionally, in each of the above-described methods, manual adjustment of a volume of specimen for sample preparation is required based on the obtained white blood cell concentration, which is time-consuming and prone to errors.

Aspects of this disclosure provide a more streamlined sample preparation process to overcome the above-discussed disadvantages of current systems and methods. For example, the sample preparation instrument 100 may include a cell concentration estimator integrated therein that estimates a white blood cell concentration in a specimen received for preparation. In one configuration, a volume of a sample of the specimen to be prepared (e.g., also referred to as the “sample volume of the specimen”) is determined based on the estimated white blood cell concentration. A sample is then automatically prepared or processed that comprises the determined sample volume of the specimen and one or more other reagents, such as labeling reagents, lytic reagents, and/or buffers. By integrating the cell concentration estimator within the sample preparation instrument 100, the white blood cell concentration estimate is performed timely and without the need to maintain and make space for an additional instrument. Additionally, the sample volume of the specimen is adjusted automatically within the sample preparation instrument 100, avoiding unnecessary errors caused by manual adjustment.

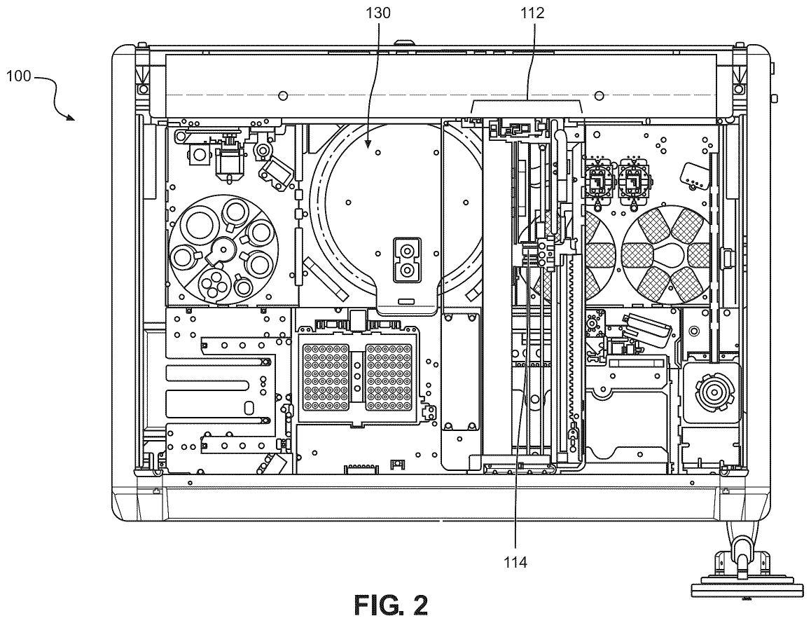

FIG. 2 depicts the hardware components of the example sample preparation unit of FIG. 1. In some embodiments, the sample preparation unit includes the cell concentration estimator, a reagent station, a reaction station, a lysing station, a transfer station 112 comprising one or more probes 114, a computing device comprising a memory and at least one processing device, a touch display, an input station, a single tube loader, a cell washer, a temperature-controlled material management unit 130 and a dry reagent carousel within the reagent station, a bead mixer, a plate mixer within the reaction station, a probe wash station, and an output station.

The probes 114 of the transfer station 112 can aspirate, transport, and dispense various substances among components of the sample preparation instrument 100. The substances can include specimens, labeling reagents, lytic reagents, diluent reagents, and buffers, among other examples. The probes 114 can pierce capped or sealed tubes, vials, cartridges, bottles, or other similar containers to aspirate the substances within or can be inserted into open-top tubes, vials, cartridges, bottles, or other similar open-top containers. In some examples, the probes are inserted into vials contained within the temperature-controlled material management unit 130.

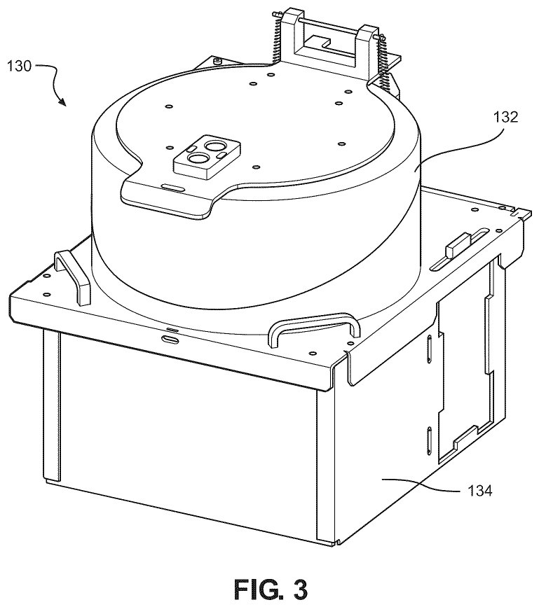

FIG. 3 is a front perspective view of an example temperature-controlled material management unit 130 in a closed configuration. In some examples, the temperature-controlled material management unit includes a temperature-controlled carousel housing module 132 and a lower refrigeration unit 134. The temperature-controlled carousel housing module 132 is positioned on top of the lower refrigeration unit 134. The lower refrigeration unit 134 houses refrigeration components such as a compressor, a condenser, an expansion device, and an evaporator.

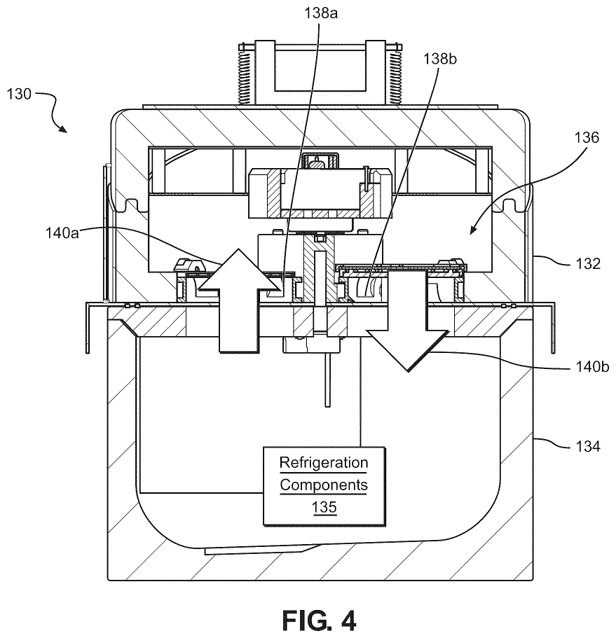

FIG. 4 is a cross sectional view of the example temperature-controlled material management unit 130 of FIG. 3 In the example of FIG. 4, the temperature-controlled carousel housing module 132 includes two fans 138a, 138b, biased to blow air into or out of an interior space 136 of the temperature-controlled carousel housing module. Using a first fan 138a, cool air 140a is blown into the interior of the temperature-controlled carousel housing module. Simultaneously, a second fan 138b works to blow warm air 140b out of the interior of the temperature-controlled carousel housing module. As noted above, the lower refrigeration unit 134 houses refrigeration components 135, which include, in some examples, a compressor, a condenser, an expansion device, and an evaporator. The refrigeration components 135 of the lower refrigeration unit 134 operate to cool the warm air 140b and produce more cool air 140a.

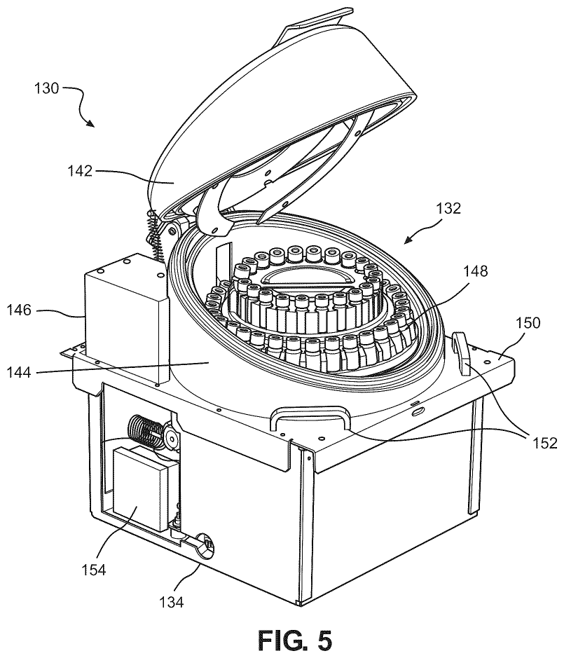

FIG. 5 is another front perspective view of the example temperature-controlled material management unit of FIG. 3 in an open configuration. As displayed, the temperature-controlled carousel housing module 132 of the temperature-controlled material management unit 130 includes a lid 142, a housing 144, an electronic components housing 146, and a material storage carousel 148. The lid 142 of the temperature-controlled carousel housing module 132 can be opened by a user to provide access to the material storage carousel 148. The temperature-controlled carousel housing module 132 further includes a bottom plate 150, and a pair of installation handles 152. The bottom plate 150 functions as a support surface for the temperature-controlled carousel housing module 132 while simultaneously serving as a cover for the lower refrigeration unit 134 when the temperature-controlled carousel housing module 132 is installed on its top side. The installation handles 152 allow a user to remove the temperature-controlled carousel housing module 132 from the lower refrigeration unit 134 when installing or taking apart the sample preparation instrument 100 or servicing components of the lower refrigeration unit 134 or the temperature-controlled carousel housing module 132.

In some examples, the lower refrigeration unit 134 includes a controller 154. The controller 154 functions to regulate the operation of the lower refrigeration unit 134 so that the temperature of the temperature-controlled material management unit 130 remains steady. In some examples, the controller 154 operates to keep the temperature of the temperature-controlled material management unit 130 between about 2° C. and about 8° C.

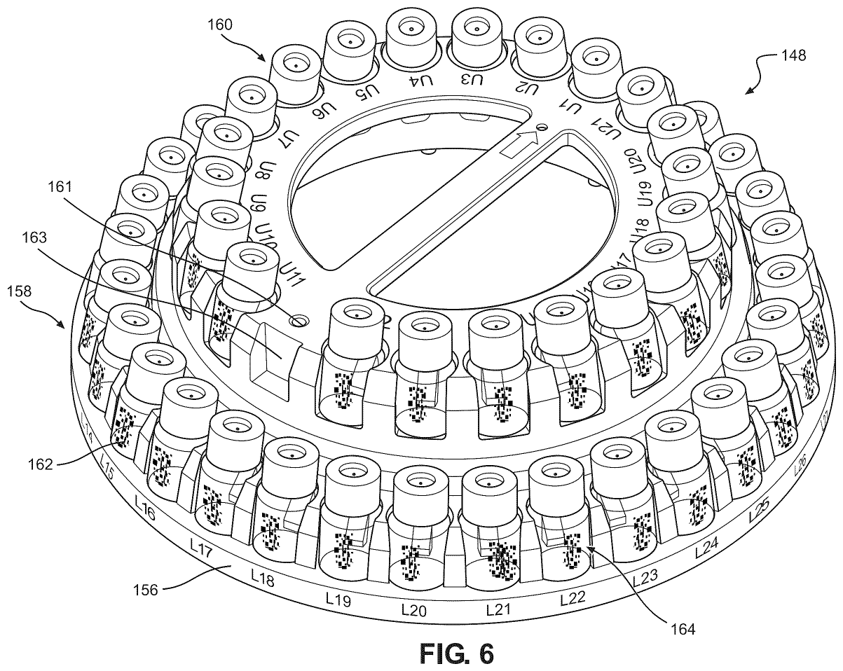

FIG. 6 is a perspective view of an example material storage carousel 148. The material storage carousel 148 includes a frame 156 with a first material storage tier 158 and a second material storage tier 160, an alignment pinhole 161, and a barcode 163. In some embodiments, the material storage carousel 148 frame 156 is aluminum, however, the frame 156 could also be made from a plastic material such as ABS or Delrin. The material storage tiers 158, 160 include a plurality of material storage compartments 164 around their perimeters. In some examples, such as the example of FIG. 6, the material storage carousel includes fifty-three identically sized material storage compartments 164. The material storage compartments 164 are sized to permit a material vial 162 to be inserted therein.

In some examples, the material vials 162 are filled with a liquid labeling reagent. Different material vial 162 types can also be positioned in the material storage carousel 148. For example, material vials 162 having flat bottoms that need to be positioned at an angle, as well as material vials 162 having v-shaped bottoms that need to be positioned vertically. In some examples, when the material vials 162 are stored within the material storage carousel 148 at an angle, the cap of the material vial 162 is directed towards the center of the material storage carousel 148 while the bottom of the material vial 162 is directed towards the outside edge of the material storage carousel 148.

In some examples, the material stored within the material vial 162 is a light sensitive material, such as, for example, a liquid labeling reagent. In these cases, it is desirable to use an opaque material vial that limits light transmissibility through the body of the vial.

In some examples, the material vials 162 have a pierceable cap. The lid 142 of the temperature-controlled carousel housing module 132 comprises two openings that align with the caps of the material vials 162 stored within the material storage tiers 158, 160 of the material storage carousel 148. In this case, a probe 114 of the transfer station 112 can enter the temperature-controlled carousel housing module 132 through one of the openings to pierce the cap of a material vial 162 positioned in the temperature-controlled carousel housing module 132 in alignment with the opening. The probe 114 can transfer liquid labeling reagent from the material vial 162 to other stations or components within the sample preparation instrument 100.

The material storage carousel 148 can be removed from or placed into the temperature-controlled carousel housing module 132 by a user. The user is able to access the material storage carousel 148, for example, by opening the lid 142 of the temperature-controlled carousel housing module 132. In this way, the assortment of material vials 162 contained within the interior space 136 of the temperature-controlled carousel housing module 132 can be altered by a user.

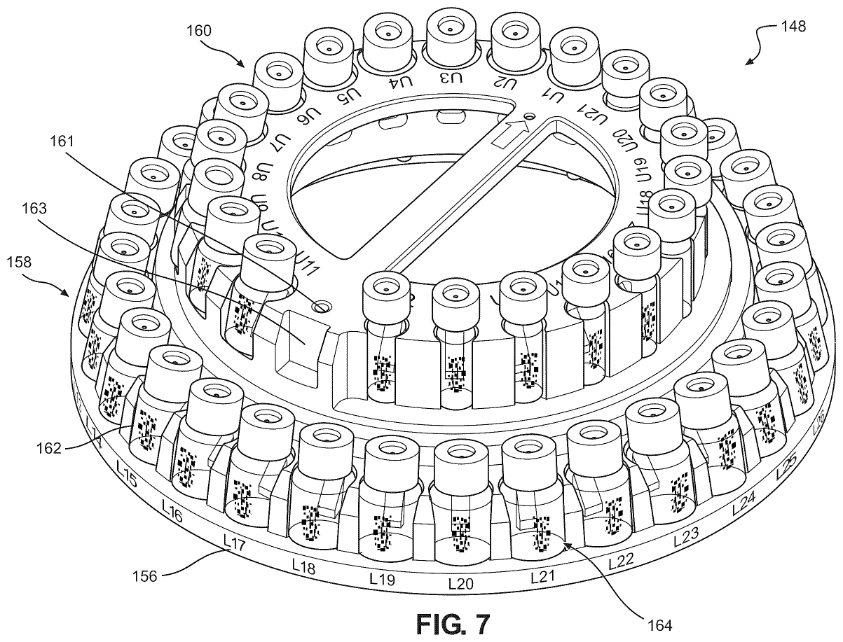

FIG. 7 is a perspective view of another example material storage carousel 148. As in the example of FIG. 6, the material storage carousel 148 includes fifty-three material storage compartments 164. However, in the example of FIG. 7, ten of the fifty-three material storage compartments 164 on the second material storage tier 160 are sized to accommodate a material vial 162 of an alternative size. In other examples, various numbers of material storage compartments 164 are included on the material storage carousel 148. In some examples, the material storage carousel barcode 163 provides identification information as to what type of material storage carousel 148 is being used within the temperature-controlled material management unit 130. For example, the barcode 163 can be scanned by the temperature-controlled material management unit 130, allowing it to determine whether the material storage carousel 148 of FIG. 6 or the material storage carousel 148 of FIG. 7 is being used.

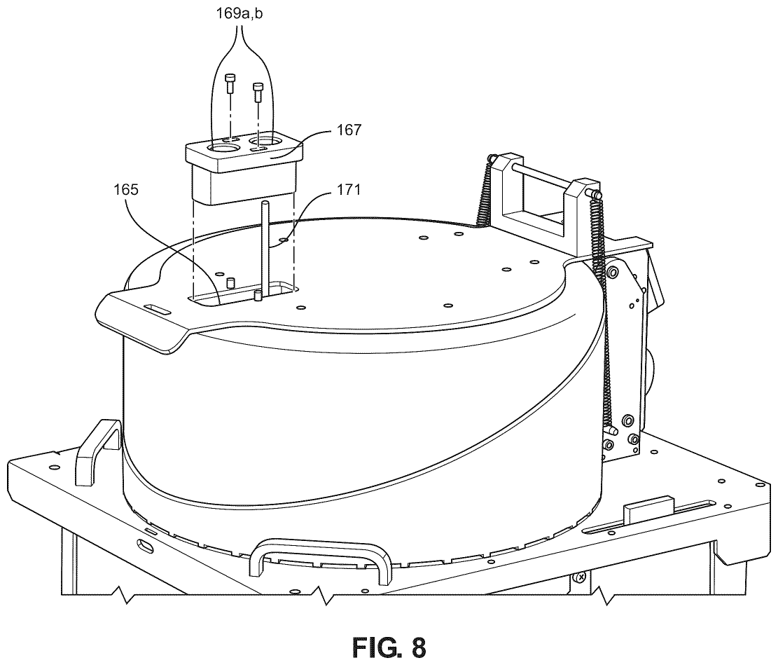

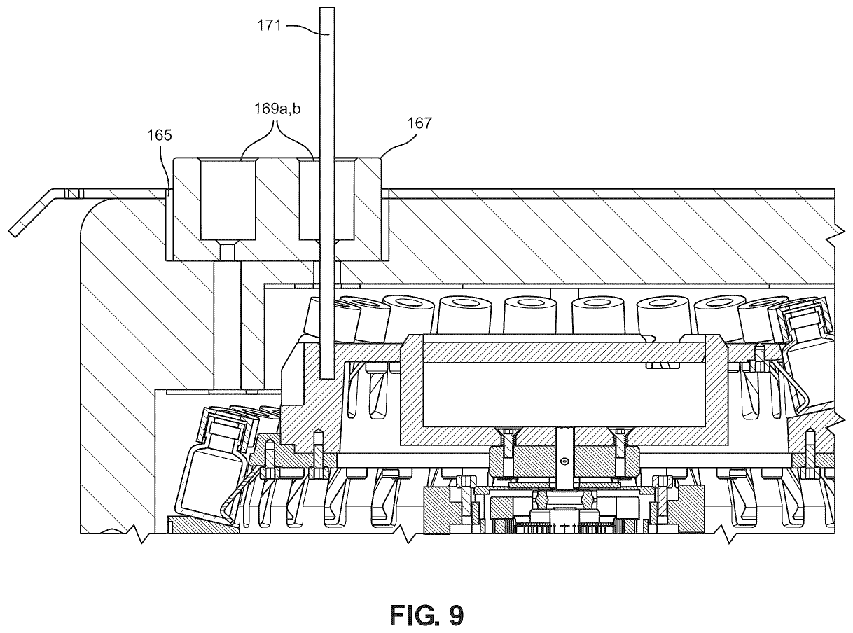

FIG. 8 is a perspective view of another example temperature-controlled material management unit 130. FIG. 9 is a cross sectional view of the example temperature-controlled material management unit 130. As seen in the example of FIGS. 8 and 9, the temperature-controlled material management unit 130 further includes a receiving hole 165, and an alignment block 167. As depicted in FIGS. 8 and 9, the alignment block 167 includes two probe holes 169 a, b, each of which is intended to align with the caps of the material vials 162 as to facilitate access to the caps by the probes 114 of the transfer station 112. The alignment block 167 is configured to be placed within the receiving hole 165 of the temperature-controlled material management unit 130, and its position within the receiving hole 165 is adjustable to account for variations in the position of the material storage carousel 148. To adjust the position of the alignment block 167, a user can insert an alignment probe 171 into one of the probe holes 169a,b. The user can then move the position of the alignment block 167 until the alignment probe 171 falls into the pinhole 161 in the material storage carousel 148. Once the user has aligned the alignment block 167 according to this process, the user can lock the alignment block 167 into place by tightening a pair of screws on the alignment block 167.

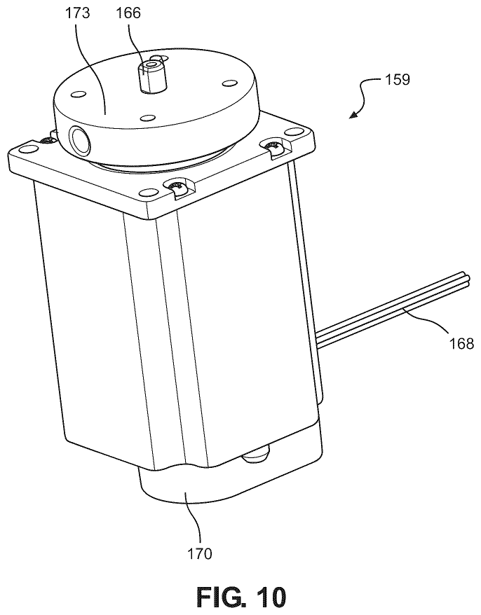

FIG. 10 is a perspective view of an example carousel motor 159. In some embodiments the driveshaft 166 of the carousel motor 159 is coupled directly to the material storage carousel 148 and operates to rotate the material storage carousel 148. A hub adapter 173 is positioned around the driveshaft 166 to facilitate coupling of the driveshaft 166 to a connecting surface of the material storage carousel 148. In some embodiments, the carousel motor 159 is propelled by a power source via the motor leads 168. The carousel motor 159 is also able to be coupled to a high-resolution encoder 170. The encoder 170 sends signals that communicate the angular position of the motor driveshaft 166 to a controller so that it only turns the material storage carousel 148 a precise, predefined amount. In some embodiments, the carousel motor 159 is a NEMA 23 stepper motor.

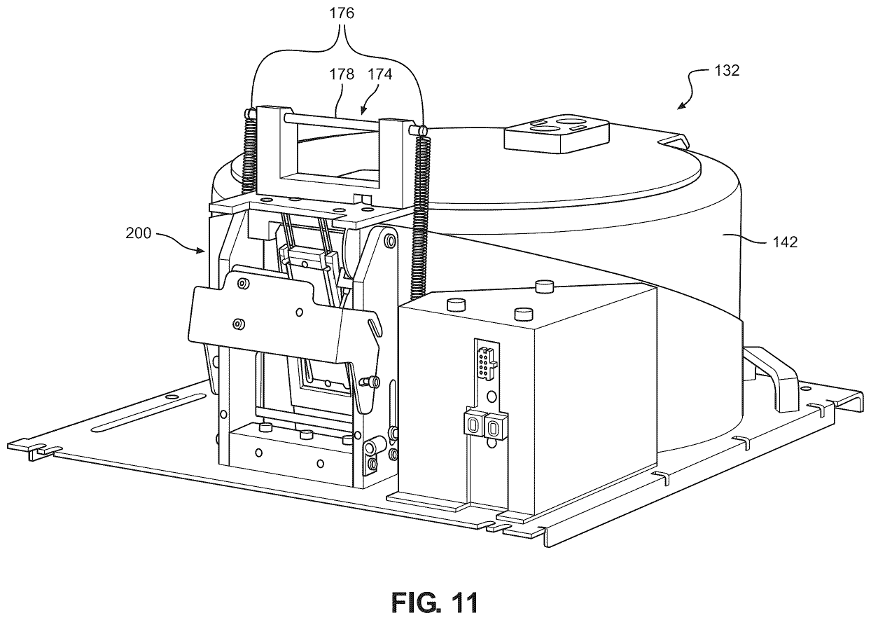

FIG. 11 is a rear perspective view of an example temperature-controlled carousel housing module 132. As depicted in FIG. 8, the temperature-controlled carousel housing module 132 further includes a hinge assembly 174, and an imaging system 200.

The hinge assembly 174 includes a pair of springs 176 connected to a hinge pin 178, held at an offset distance from the surface of the lid 142. Because the hinge pin 178 is held at the offset distance from the lid 142, depending on its position, the lid 142 can be biased by the springs 176 into an open or closed state. For example, when the lid 142 is in a near open position, the springs 176 function to provide an opening force to the lid 142. Likewise, when the lid 142 is in a near closed position, the springs 176 function to provide a closing force to the lid 142.

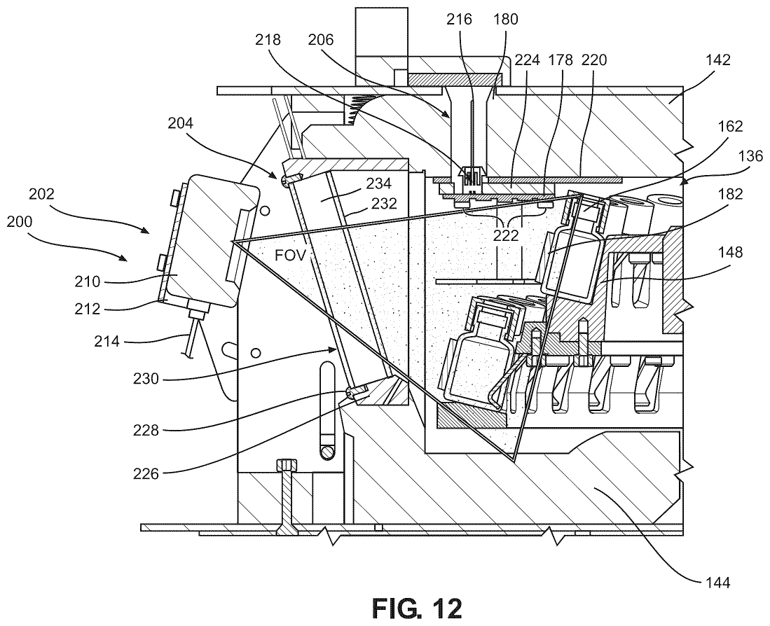

The imaging system 200 functions to capture images of barcodes affixed to the material vials 162 and is described in greater detail in FIG. 12.

FIG. 12 is a cross sectional view of the example temperature-controlled carousel housing module 132 of FIG. 5. As previously mentioned, the temperature-controlled carousel housing module 132 includes the housing 144, the lid 142, the interior space 136, the material storage carousel 148, and the material vials 162. The temperature-controlled carousel housing module further includes an access port 180, and an imaging system 200. In some examples, the housing 144 includes a layer of integral skin insulating foam that provides insulation to the housing 144. Likewise, in some examples, the lid 142 includes a layer of integral skin insulating foam that provides insulation to the lid 142. Because of the insulation provided by the housing 144 and the lid 142, the interior space 136 of the temperature-controlled carousel housing module 132 can be kept at refrigerated temperatures as to ensure the quality of the material stored within the material vials 162.

In some examples, the access port 180 is formed through the lid 142. The access port 180 provides access to the interior space 136 of the temperature-controlled carousel housing module 132. In some embodiments, the access port 180 is blocked by an insulating insert or insulating lid when not in use. Blocking the access port 180 with insulating material further enhances the ability of the temperature-controlled material management unit 130 to maintain refrigerated temperatures within the interior space 136 and ensure the quality of the material stored within the material vials 162.

As noted above, material vials 162 can take different shapes and may be used with different types of caps. In some examples, the material vials 162 also include labels 182. In some examples, the labels 182 are affixed to the side of the material vials 162 by an adhesive. The labels 182 include various identification information about the material stored within the material vial 162. In some examples, the labels 182 include a barcode that encodes identification information. In some examples, the barcodes are a 1D barcode or a 2D barcode such as a data matrix or QR code. When placed in the material storage carousel 148, the material vials 162 are oriented so that the labels 182 face away from the center of the material storage carousel 148. In this orientation, the material vial 162 labels 182 are viewable as the material vials 162 are stored onto the material storage carousel 148. In some examples, the material vials 162 are configured to house light-sensitive materials, such as a labeling reagent or an antibody reagent. In this configuration, the material vials 162 are made from an opaque material that functions to shield the light-sensitive materials from light sources outside of the material vials 162.

In some examples, the imaging system 200 includes a camera assembly 202, a window assembly 204, a light assembly 206, and a controller 208 (not shown in FIG. 12). In some examples, the imaging system 200 functions to permit the temperature-controlled material management unit 130 to capture and store images of the barcode labels on the material vials 162 stored within the temperature-controlled carousel housing module 132. By capturing images of the barcode labels 182 on the material vials, the temperature-controlled material management unit 130 is able to initialize itself based on what material vials 162 are stored within the material storage carousel 148. Images of the barcode labels 182 are captured, for example, after a user closes the lid 142 of the temperature-controlled carousel housing module 132, or before the probes 114 access materials stored within the material vials 162. By capturing images of the barcodes labels 182 on the material vials, the temperature-controlled material management unit 130 is able to confirm the identity of the materials stored therein.

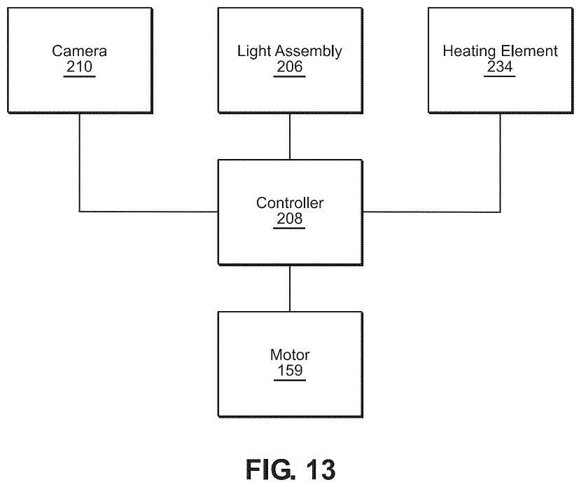

Broadly speaking, the controller 208 signals to the camera assembly 202 to take an image of the barcode label 182 on the material vial 162. The camera assembly 202 captures an image of the interior space 136 of the temperature-controlled carousel housing module 132, through the window assembly 204. The controller 208 simultaneously triggers the light assembly 206 to illuminate the interior space 136 of the temperature-controlled carousel housing module 132 to facilitate the image acquisition by the camera assembly 202. The controller 208 is discussed in greater detail with reference to FIG. 13.

The camera assembly 202 includes a camera 210, and mounting bracket 212. In some examples, the camera 210 includes electrical leads 214 to facilitate communication with the controller 208 or to supply the camera 210 with electrical power. In other examples, the camera 210 communicates wirelessly or is battery powered. In some examples, the camera 210 is a digital camera, while in other examples, the camera 210 is a barcode scanner. Generally, the camera 210 includes an imaging face, which in some cases, is a camera lens, and in other examples, includes a laser beam and photodiode barcode scanning system. Images are generally captured by the camera 210 in a direction perpendicular to a plane defined by the imaging face. In some examples, the camera is mounted to a mounting bracket 212. The mounting bracket 212 is connected to the temperature-controlled carousel housing module 132, and in some examples, is adjustable so that a user may adjust the orientation of the camera 210 so that the imaging face points towards a desired imaging target. In some examples, the imaging target is the barcode label 182 on the material vials 162 within the temperature-controlled carousel housing module 132. As described above with reference to FIG. 6, in some examples, the material vials 162 are held on the material storage carousel 148 at an angle. The mounting bracket 212 permits a user to adjust the angle of the camera 210 so that the angle of the imaging face approximates the angle that the material vial 162 is held at by the material storage carousel 148. By matching the angle of the material vials 162, a user may enhance the quality of the barcode label 182 captured by the camera 210.

The light assembly 206 functions to provide light to the image target as to aid the imaging system 200 in capturing images. In some examples, the light assembly 206 is positioned within the interior space 136 of the temperature-controlled carousel housing module 132. In some examples, the light assembly 206 includes an electrical lead portion 216, a connector 218, a circuit board 220, a plurality of light sources 222, and an insulation portion 224. The electrical lead portion 216 is configured to carry electrical signals to the circuit board 220 from the controller 208, and is connected to the circuit board 220 by a connector 218. In some embodiments, the controller 208 is located outside the interior space 136 of the temperature-controlled carousel housing module 132 and the electrical lead portion 216 passes through the access port 180 to carry electrical signals from the controller 208 into the interior space 136 and deliver them to the circuit board 220, which is located within the interior space 136. The circuit board 220 transmits the electrical signals to the light sources 222, which illuminate upon receiving the electrical signals. In some embodiments, the light sources 222 include one or more white LEDs. In some embodiments, the light sources 222 are connected to the circuit board 220 and positioned above each material storage tier 158, 160, as to illuminate the material vials 162 positioned below the light sources.

In some examples, the light assembly only illuminates the material vials for a short, predetermined time. This type of lighting is desirable, for example, when storing light-sensitive materials within the inner space of the temperature controlled-carousel housing module. When limiting the lighting in this way, the controller signals the light assembly to illuminate the material vials only when the image acquisition process is underway. In this way, the amount of light provided within the inner space is limited as to reduce the amount of light exposure experienced by the light sensitive materials.

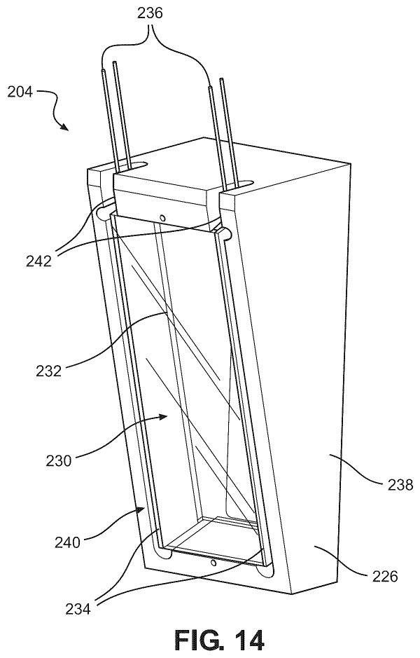

The window assembly 204 includes a window frame 226, window mounting screws 228, and a thermal window 230. The thermal window includes a window 232, and a heating element 234. In some examples, the heating element 234 functions to provide heat to the window 232 and includes electrical leads that connect to a controller 208 and provide power to the heating element 234. In some embodiments, the heating element 234 is attached to the side of the window 232, as depicted in FIG. 12, and provides heat to the side of the window 232. The window 232 is held in place by the window frame 226. The window frame engages with an opening in the housing 144, and is sized to receive the thermal window 230. The window frame 226 also includes two tapped holes, into which the window mounting screws 228 thread. The tapped holes are positioned adjacent to the thermal window 230 so that the head of the window mounting screws 228 overlap the edge of the thermal window 230 and hold the thermal window 230 in place. In some examples, the window frame 226 includes two tapped holes and two mounting screws 228, while in other embodiments, the window frame 226 includes greater or fewer tapped holes and mounting screws 228. The window assembly 204 is discussed in greater detail with reference to FIG. 14.

As noted above, when the temperature-controlled carousel housing module 132 is in use, the interior space 136 is kept at a refrigerated temperature. In some examples, the interior space 136 is kept at a temperature between about 2° C. and about 8° C. Low temperatures, such as the temperatures within the interior space 136 have the potential to cause performance issues with the camera 210. For this reason, it becomes useful to remove the camera 210 from the interior space 136 and capture images of the interior space 136 through the window 232. Although this configuration protects the functionality of the camera 210, problems may occur when attempting to obtain an image through the window 232. For example, the temperature differential between the interior space 136 and the ambient conditions outside of the temperature-controlled carousel housing module 132 may cause condensation to appear on the exterior surface of the window 232. In some cases, the condensation distorts the captured image so that the imaging system 200 is unable to read the barcode label 182. Likewise, reflections from the window 232 surface during the image acquisition process may obscure the images of the barcode labels 182. Adaptations to the imaging system 200 made to address these functional issues are discussed in greater detail with reference to FIG. 14.

FIG. 13 is an example block diagram depicting the connection between the controller 208, the camera 210, light assembly 206, and heating element 234. As depicted in the example of FIG. 10, the controller 208 is separately connected to each of the camera 210, light assembly 206, and heating element 234. However, in some examples, the controller 208 is connected to additional components within the temperature-controlled material management unit 130, such as the refrigeration components 135 or the motor 159. Alternatively, in other examples, the controller 208 is connected to fewer components, in which case the components are not powered by a controller 208 but are instead connected directly to a power source. Although the controller 208 is referred to and depicted in the singular sense, in some embodiments the controller 208 includes a plurality of distinct controllers 208, in which case the various components within the temperature-controlled material management unit 130 are able to be connected to separate controllers 208. Furthermore, in other examples, the controller 208 may be a master system controller 208 of the sample preparation instrument 100, which controls the operation of many different components within the sample preparation instrument 100. In the same way, controllers 208 connected to individual system components may also be connected to a master system controller 208 of the sample preparation instrument 100, in which case the master system controller 208 operates to control the operation of the individual component controllers 208.

FIG. 14 is a perspective view of the example window assembly 204. As noted above, with reference to FIG. 12, the window assembly 204 includes a window frame 226, window mounting screws 228 (not shown in FIG. 14), and a thermal window 230. The window frame 226 and window mounting screws 228 hold the thermal window in position on the housing of the temperature-controlled carousel housing module 132. The thermal window 230 includes a window 232 and a heating element 234. In some examples, the heating element 234 functions to provide heat to the window 232 and includes electrical leads 236 that connect to a controller 208 and provide power to the heating element 234.

In some examples, the window 232 is a glass window, or more specifically, a Borosilicate glass made from an H-K9L type-material. The window 232 may be various shapes and sizes. In some examples, the window 232 is rectangular and has a length of 76.2 mm, a width of 25.4 mm, and a thickness of 16.0 mm. In this example, the window 232 includes six surfaces. One of the surfaces with a 76.2 mm length and a 25.4 mm width is an interior surface, one of the surfaces with a 76.2 mm length and a 25.4 mm width is the exterior surface, one of the surfaces with a 76.2 mm length and 16.0 mm width is a left side surface, one of the surfaces with a 76.2 mm length and 16.0 mm width is a right side surface, one of the surfaces with a length of 25.4 mm, and a width of 16.0 mm is a top surface, and one of the surfaces with a length of 25.4 mm, and a width of 16.0 mm is a bottom surface. The window may be processed in a variety of different ways. In some examples, the side surfaces of the window are finely or coarsely ground, as to facilitate adherence to an adhesive material. Likewise, in some examples the edges of the window are beveled or chamfered.

As noted above, issues associated with reflections in the window 232 may arise during the image acquisition process. In some examples, to mitigate these issues, a coating is applied to the surface of the window 232. Various coatings may be applied to the surfaces of the window 232. Example coatings include antireflective coatings such as single layer antireflective coatings, multi-layer broadband antireflective coatings, V-coat antireflective coating, and dual band anti-reflective coating. In some examples, the coatings are applied to multiple surfaces of the window 232, while in others, the coatings are applied to just the interior or exterior surface of the window 232. In other examples, a separate opaque coating is applied to the window to limit the light transmitted through the window from the exterior of the temperature-controlled material management unit. These coatings may be desirable, for example, when storing light-sensitive material within the interior of the temperature-controlled carousel housing module 132. As with the antireflective coating, the opaque coating can be applied to various surfaces of the window 232. In some examples, the opaque coating is applied only to the interior or exterior surface of the window 232.

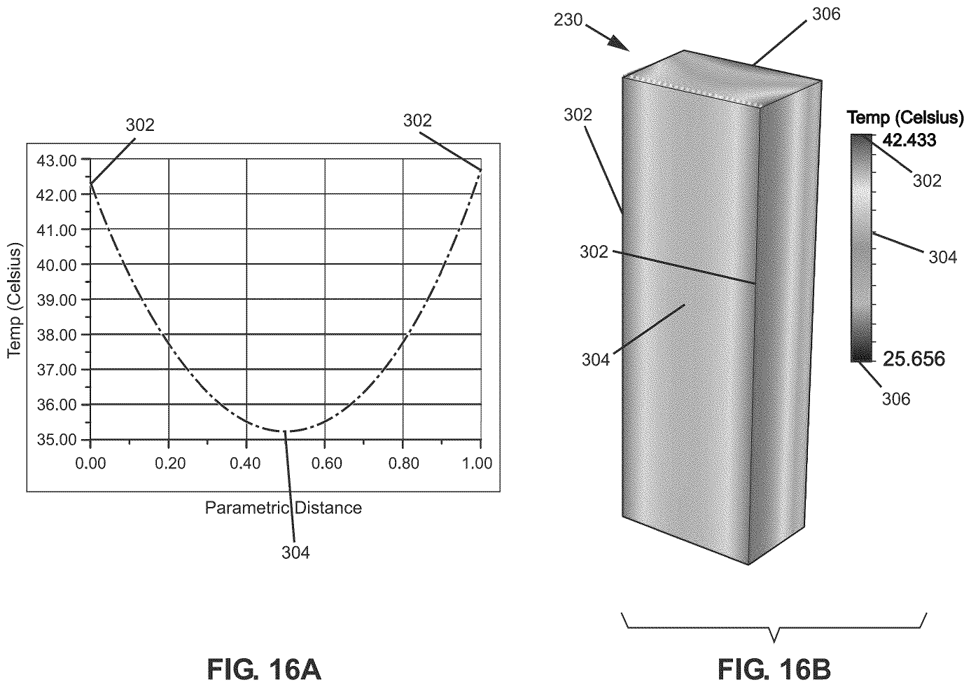

Similarly, as noted above, condensation may appear on the window 232 and distort the image captured may the imaging system 200. In some embodiments, the condensation occurs due to the temperature differential on each side of the window 232. For example, when the interior space 136 is held at a sufficiently low temperature relative to the ambient laboratory temperatures, the temperature of the window 232 decreases. Accordingly, the temperature of the exterior surface of the window 232 may be a lower temperature than the ambient laboratory temperature. If the temperature of the exterior surface of the window 232 is sufficiently low relative to the ambient laboratory temperature, and if the laboratory is at a sufficiently high humidity level, condensation will tend to appear on the exterior surface of the window 232. In some examples, to counteract this phenomenon, a heating element 234 is used in conjunction with the window 232. Additional explanation of how the heating elements function to mitigate issues associated with window condensation is provided with reference to FIG. 16.

The heating element 234 can be, for example, a resistance wire heating element, a ceramic or semiconductor heating element, a thick film heating element, a polymer PTC heating element, a composite heating element, or a combination heating element. In some examples the heating element is a resistive heating strip. The resistive heating strip 234 includes one or more electrical leads 236 and an adhesive. The electrical leads 236 operate to transmit power from a power source to the resistive heating strip 234. In some examples, the electrical leads 236 are connected to a controller 208, which selectively applies power through the electrical leads 236 to the heating strip 234. As power is applied, the resistive elements within the heating strip 234 generate heat, which causes the heating strip 234 to generate heat along its length. In some examples, 24 volts of electricity is provided to the heating strip 234 by a power source. In some examples, the heating strips 234 are constantly powered and each produce about 1.37 watts of heat. The adhesive is applied to one or more sides of the heating strip 234 and secures the heating strip 234, for example, to the window 232. The heating strip 234 may come in various shapes and sizes. However, in some examples, the heating strip 234 is rectangular and is approximately the same size as a cross section of the window 232.

Heating strips 234 can be applied to a window 232 in different configurations. For example, multiple heating strips 234 may be applied to the window 232 to heat the window 232 in various locations. In some examples, the heating strips 234 are only applied to the sides of the window 232. In other examples, such as the example of FIG. 10, two heating strips 234 are applied to the window 232. In this example, a heating strip 234 is applied to each of the left and the right-side surface of the window 232.

As noted above, the window frame 226 holds the thermal window 230 in place. The window frame 226 includes an engagement portion 238 which engages with an opening in the housing 144. In some examples, the engagement portion 238 of the window frame 226 is press-fit into an opening in the housing 144 of the temperature-controlled carousel housing module 132, however, in other examples, the window frame 226 is glued into place or secured with a fastener. The window frame 226 also includes an opening 240 into which the thermal window 230 is placed. In some examples, the opening 240 is sized to accommodate a press-fit of the thermal window 230 into the opening 240, however, in other examples, the thermal window 230 is held in place by the window mounting screws 228, which thread into the tapped holes. In some examples, the window 232 is held in place by a combination of the press-fit and the window mounting screws 228. In some instances, a user may wish to remove the thermal window 230 from the window frame 226. This situation may occur when, for example, parts of the thermal window 230 are damaged. In some embodiments, a user can remove the thermal window 230 from the window frame 226 as one unit. To remove the thermal window 230, a user removes the window mounting screws 228 so that the window 232 is loose within the window frame 226. Thus, the thermal window 230, including the window 232 and heating elements 234, can be removed as a single unit.

In some examples, the window frame 226 opening is sized to approximately match the dimensions of the window 232. In other examples, however, the opening 240 is sized to accommodate the heating elements 234 of the thermal window 230. In the example of FIG. 10, the opening 240 is sized to match the dimension of the window 232 length, but is oversized in the window 232 width direction to accommodate a heating element 234 on the left and right sides of the window 232. Similarly, in some embodiments, the window frame 226 includes cutouts 242 to accommodate the routing of the electrical leads 236 of the heating elements 234 out of the window frame 226. In the example of FIG. 10, the cutouts 242 are located on the window frame 226 adjacent to where the opening 240 contacts the top surface of the window 232. In other embodiments, the cutouts 242 are placed elsewhere on the window frame 226 to accommodate various configurations of electrical leads 236.

The window frame 226 can be made from a variety of materials. In some examples, the window frame 226 is made from an aluminum or composite material. In other examples, the window frame 226 is made from a plastic material such as ABS, polycarbonate, polyethylene, polypropylene, or Delrin.

As noted above, issues associated with reflections in the window 232 may arise during the image acquisition process. In some examples, these issues are further mitigated by positioning the window 232 at an angle relative to the vertical housing 144 wall of the temperature-controlled carousel housing module 132. In the example of FIG. 10, the window frame 226 is configured to position the window 232 at a downward angle, such that the exterior surface of the window 232 faces away from the temperature-controlled carousel housing module 132 and down towards the lower refrigeration unit 134. By varying the angle of the window 232, reflections created by the window 232 can be adjusted as to not interfere with the image acquisition process. In some examples, the window is held at an angle of between 1° and 45° from a vertical position. In other examples, the window is held at an angle of 170+/−0.5° from a vertical position. In some embodiments, both the camera and the window are held at an angle from a vertical position. In some examples, the camera is held at an angle of between 1° and 45° from a vertical position. In other examples, the camera is held at an angle of 13°+/−3° from a vertical position. In some examples, the camera angle is held at a smaller angle from a vertical position than the window. By adjusting the angle of the camera and the window, a user can mitigate the effects of window reflections on the captured image quality.

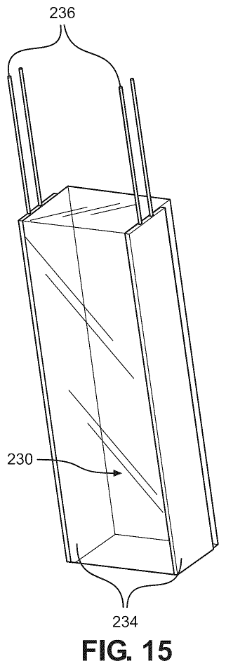

FIG. 15 is a perspective view of an example thermal window 230. As described above, in some examples, such as the example of FIG. 14, the thermal window 230 includes a pair of heating strips 234 provided on the left and the right surfaces of the window 232. As seen in the example of FIG. 10, the heating strips 234 cover approximately the entire surface of the left and right surfaces of the window 232.

FIG. 16A and FIG. 16B is a representation of the temperature on and within the example thermal window 230 of FIG. 15. FIG. 16A depicts a graphical representation of the temperature along the width of the surface of the exterior surface of the thermal window 230 between the heating strips 234, when used in conjunction with the temperature-controlled material management unit 130. FIG. 16B provides an example visual depiction of the temperature distribution on the surfaces of the thermal window, when used in conjunction with the temperature-controlled material management unit 130. The example visual depiction of FIG. 16B corresponds to the same example conditions as the graphical representation of FIG. 16A. As noted by reference numbers 302 on FIGS. 16A and 16B, the exterior surface edges 302 of the thermal window 230 are maintained at a temperature of approximately 42.433 C. Moving from the exterior surface edges 302 to the exterior surface middle 304 of the thermal window, the temperature of the thermal window steadily decreases. In some examples, as noted by reference number 304, the exterior surface middle 304 of the thermal window 230 is the coolest point on the exterior surface of the thermal window 230 and reaches approximately 35.2 C. The coolest points on the thermal window 230 generally are located on the internal surface of the thermal window. In some examples, the internal surface middle 306 of the thermal window 230 is the coolest point on the thermal window 230. As noted by reference number 306, in some examples, the internal surface middle 306 of the thermal window is approximately 25.656 C. As depicted in FIG. 16A, all points on the exterior surface of the thermal window 230 remain at a temperature greater than 35° C. Although the interior surface of the thermal window 230 is subject to the refrigerated temperatures of the interior space 136, the heating elements 234 provided on the left and right sides of the thermal window 230 counteract the cooling effect of the interior space 136 on the window 232 by applying heat to the window 232. In some examples, such as the example of FIG. 16A and FIG. 16B, the heating elements 234 provide sufficient heat to the window 232 so that all points on the exterior surface of the thermal window 230 are kept at a sufficiently high temperature to prevent condensation from forming thereon. In some examples, such as in laboratory conditions of 22° C. and a relative humidity level of 60%, the dew point temperature is about 13.9° C. In other examples, such as in laboratory conditions of 30° C. and a relative humidity level of 90%, the dew point temperature is about 28° C. In the example of FIG. 16A and FIG. 16B, the exterior surface of the thermal window 230 is kept at a sufficiently high temperature as to not drop below the dew point temperature in either case.

This disclosure should be understood to include (as illustrative and not limiting) the subject matter set forth in the following numbered clauses:

Clause 1: A material management unit comprising:
a refrigerated chamber with an interior refrigerated space, the refrigerated space being held at a lower temperature than an exterior space outside of the refrigerated chamber;
a window positioned on the material management unit separating the exterior space from the refrigerated space, a first surface of the window is exposed to the exterior space, a second surface of the window is exposed to the refrigerated space, and a third surface of the window spans between the first surface and the second surface;
a heating element configured to apply heat to the third surface of the window; and
a camera positioned in the exterior space and oriented to capture image data of the refrigerated space through the window.

Clause 2: The material management unit of clause 1, wherein the first surface of the window defines a first plane, and wherein the first plane is positioned at an angle relative to a vertical plane defined by a wall of the material management unit.

Clause 3: The material management unit of clause 2, wherein the camera includes an imaging face that defines a second plane, wherein the angle between the first plane and the vertical plane defines a first angle, and wherein the angle between the second plane and a vertical plane defines a second angle, wherein the first angle is greater than the second angle.

Clause 4: The material management unit of any one of clauses 1-3, wherein the refrigerated chamber houses a plurality of vials, wherein the camera is configured to capture an image of a barcode affixed on a vial.

Clause 5: The material management unit of any one of clauses 1-4, wherein the window is coated with an antireflective coating.

Clause 6: A thermal window unit, comprising:
a window comprising a first surface, a second surface, and an edge; and
a heating element configured to apply heat to the edge of the window, the heating element being configured to heat at least one of the first surface and the second surface to at least 35 degrees Celsius.

Clause 7: The thermal window unit of clause 6, wherein the heating element comprises a plurality of heating strips.

Clause 8: The thermal window unit of clause 7, wherein the edge of the window comprises four surfaces and the heating strips are attached to at least two opposing surfaces of the edge.

Clause 9: The thermal window unit of any one of clauses 7-8, wherein the heating strips are adhesive backed resistance heat strips.

Clause 10: The thermal window unit of any one of clauses 6-9, wherein at least one of the first surface and the second surface is coated with an antireflective coating.

Clause 11: An imaging system comprising:
a window with a first surface, a second surface, and an edge spanning between the first surface and the second surface;
a camera with an imaging face oriented to capture image data through the first surface and second surface of the window; and
a heating element configured to apply heat to the edge of the window.

Clause 12: The imaging system of claim 11, further comprising a light assembly positioned opposite the window from the camera, wherein the light assembly is configured to illuminate a subject of the image data.

Clause 13: The imaging system of any one of clauses 11-12, wherein the imaging face of the camera and at least one of the first surface and second surface of the window are positioned at an angle relative to each other.

Clause 14: The imaging system of any one of clauses 11-13, wherein the heating element is one or more resistive heating strips.

Clause 15: The imaging system clause 14, wherein the resistive heating strip is attached to the edge of the window with an adhesive.

Clause 16: The imaging system of any one of clauses 11-15, wherein the window is a borosilicate glass.

Clause 17: The imaging system of any one of clauses 11-16, wherein the first surface and second surface of the window are rectangular shaped and have a length dimension and a width dimension, wherein the length dimension is greater than the width dimension, and wherein the heating element applies heat to the two edges of the window adjacent to the length dimension.

Clause 18. A sample preparation unit comprising:
a material management unit configured to store a plurality of material vials within a refrigerated interior space, the material management unit further comprises:
   a material storage carousel configured to hold the plurality of material vials within the refrigerated interior space; and
   an imaging system comprising:
      a window separating the refrigerated interior space from an exterior space of the material management unit;
      a camera positioned in the exterior space of the material management unit and configured to capture image data of the interior space through the window; and
      a heating element configured to apply heat to an edge of the window; and
a transfer station configured to access the material stored within the plurality of the material vials.

Clause 19. The sample preparation unit of clause 18, wherein the camera is configured to capture image data of barcodes affixed to the material vials.

Clause 20. The sample preparation unit of any one of clauses 18-19, wherein the heating element is a resistive heating strip.

Clause 21. The sample preparation unit of any one of clauses 18-20, wherein the window is coated with an antireflective coating.

Clause 22. The sample preparation unit of any one of clauses 18-21, wherein a first surface of the window is exposed to the exterior space, a second surface of the window is exposed to the refrigerated space, and a third surface of the window spans between the first surface and the second surface.

Clause 23. The sample preparation unit of clause 22, wherein the first surface of the window defines a first plane, and wherein the first plane is positioned at an angle relative to a vertical plane defined by a wall of the sample preparation unit.

Clause 24. The sample preparation unit of clauses 23, wherein the camera includes an imaging face that defines a second plane, wherein the angle between the first plane and the vertical plane defines a first angle, and wherein the angle between the second plane and a vertical plane defines a second angle, wherein the first angle is greater than the second angle.

Clause 25. The sample preparation unit of any of any one of clauses 18-24, wherein the edge of the window comprises four surfaces and the heating element is attached to at least two opposing surfaces of the edge.

Clause 26. The sample preparation unit of any one of clauses 18-25, wherein the heating element comprises one or more adhesive backed resistance heat strips.

Clause 27. The sample preparation unit of any one of clauses 17-26, further comprising a light assembly positioned opposite the window from the camera, wherein the light assembly is configured to illuminate a subject of the image data.

Clause 28. The sample preparation unit of any one of clauses 18-27, wherein the window is a borosilicate glass.

Clause 29. The sample preparation unit of any clauses 22-23, wherein the first surface and second surface of the window are rectangular shaped and have a length dimension and a width dimension, wherein the length dimension is greater than the width dimension, and wherein the heating element applies heat to two edges of the window adjacent to the length dimension.

Clause 30. The sample preparation unit of any one of clauses 18-29, further comprising a power source configured to supply power to the heating element.

Clause 31. The sample preparation unit of any of claims 18-30, wherein the window provides visibility into the refrigerated interior space from the exterior space, and wherein the heating element is positioned so that it does not obscure the visibility into the refrigerated interior space.

Clause 32. The sample preparation unit of clause 27, wherein the light assembly is configured to selectively illuminate a subject of the image data while the camera captures the image data.

Clause 33. A sample preparation unit comprising:
a refrigerated chamber having a window; and
a heating element coupled to the window.

Clause 34. The sample preparation unit of clause 33, further comprising a power source configured to supply power to the heating element.

Clause 35. The sample preparation unit of any one of clauses 33-34, wherein the window includes first and second opposing surfaces and at least one edge surface extending between the first and second surfaces, wherein the heating element is coupled to the at least one edge surface.

Clause 36. The sample preparation unit of any one of clauses 33-35, wherein the window provides visibility into the refrigerated chamber from exterior to the refrigerated chamber, and wherein the heating element is positioned so that it does not obscure the visibility into the refrigerated chamber.

Clause 37. A method of capturing an image comprising:
positioning a camera outside of a refrigerated chamber to capture an image of an interior space of the refrigerated chamber though a window;
the refrigerated chamber includes:
   the window, which further comprises:
      a window first surface facing external to the refrigerated chamber and a window second surface facing internal to the refrigerated chamber;
      a window side surface extending between the window first surface and the window second surface; and
   a heating element configured to apply heat to the window side surface; and
operating the camera to capture the image.

Clause 38. The method of clause 37, wherein the window further comprises a plurality of window side surfaces, wherein the heating element applies heat to at least two of the plurality of window side surfaces.

Clause 39. A method of reducing condensation buildup on a window of a refrigerated chamber of a sample preparation unit, the window being positioned between an interior region and an exterior region of the refrigerated chamber the method comprising applying heat to the window to reduce condensation buildup on an exterior surface of the window.

Clause 40. The method of clause 39, wherein the heat is applied to an edge surface of the window using a heating element coupled thereto.

Clause 41. A method of identifying a vial within a refrigerated chamber, the method comprising:
applying heat to a window of the refrigerated chamber; and
capturing an image of at least a portion of the vial, the vial including an identifier arranged on the vial, the image being captured through the heated window; and
identifying the vial using the identifier.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A sample preparation unit comprising:
a material management unit configured to store a plurality of material vials within a refrigerated interior space, the material management unit further comprises:
a material storage carousel configured to hold the plurality of material vials within the refrigerated interior space; and
an imaging system comprising:
a window separating the refrigerated interior space from an exterior space of the material management unit;
a camera positioned in the exterior space of the material management unit and configured to capture image data of the interior space through the window; and
a heating element configured to apply heat to an edge of the window; and
a transfer station configured to access material stored within the plurality of the material vials.

2. The sample preparation unit of claim 1, wherein the camera is configured to capture image data of barcodes affixed to the material vials.

3. The sample preparation unit of claim 1, wherein the heating element is a resistive heating strip.

4. The sample preparation unit of claim 1, wherein the window is coated with an antireflective coating.

5. The sample preparation unit of claim 1, wherein a first surface of the window is exposed to the exterior space, a second surface of the window is exposed to the refrigerated space, and a third surface of the window spans between the first surface and the second surface.

6. The sample preparation unit of claim 5, wherein the first surface of the window defines a first plane, and wherein the first plane is positioned at an angle relative to a vertical plane defined by a wall of the sample preparation unit.

7. The sample preparation unit of claim 6, wherein the camera includes an imaging face that defines a second plane, wherein the angle between the first plane and the vertical plane defines a first angle, and wherein the angle between the second plane and the vertical plane defines a second angle, wherein the first angle is greater than the second angle.

8. The sample preparation unit of claim 1, wherein the edge of the window comprises four surfaces and the heating element is attached to at least two opposing surfaces of the edge.

9. The sample preparation unit of claim 1, wherein the heating element comprises one or more adhesive backed resistance heat strips.

10. The sample preparation unit of claim 1, further comprising a light assembly positioned opposite the window from the camera, wherein the light assembly is configured to illuminate a subject of the image data.

11. The sample preparation unit of claim 1, wherein the window is a borosilicate glass.

12. The sample preparation unit of claim 5, wherein the first surface and second surface of the window are rectangular shaped and have a length dimension and a width dimension, wherein the length dimension is greater than the width dimension, and wherein the heating element applies heat to two edges of the window adjacent to the length dimension.

13. The sample preparation unit of claim 1, further comprising a power source configured to supply power to the heating element.

14. The sample preparation unit of claim 1, wherein the window provides visibility into the refrigerated interior space from the exterior space, and wherein the heating element is positioned so that it does not obscure the visibility into the refrigerated interior space.

15. The sample preparation unit of claim 10, wherein the light assembly is configured to selectively illuminate a subject of the image data while the camera captures the image data.
